(19) United States
(12) Patent Application Publication
(10) Pub. No.: US 2026/0357730 A1
(43) Pub. Date: Nov. 12, 2026

(54) METHOD AND SYSTEM FOR MOBILE POWER GENERATION

(71) Applicant: TY-CROP MANUFACTURING LTD., Rosedale (CA)

(72) Inventors: Joshua Dyck, Calgary (CA); Gary Wayne Teichrob, Rosedale (CA); Russell Lee Janzen, Chilliwack (CA); Ian Breeweg, Orton (CA); Dennis Keith HO, Abbotsford (CA); Allen James Kropp, Chilliwack (CA); Christopher Karl Le Cheminant, Airdrie (CA)

(21) Appl. No.: 19/204,239

(22) Filed: May 9, 2025

(51) Int. Cl. F01N 3/02; F01N 3/28; F01N 13/00; F02B 63/04; F28D 7/00; F28D 21/00

(52) U.S. Cl. CPC F01N 3/0205; F01N 13/002; F28D 7/0066; F01N 3/2885; F01N 3/2889; F01N 2260/06; F01N 2510/02; F02B 63/04; F02B 63/044; F02B 63/047; F28D 21/0003; F28D 21/001

(57) ABSTRACT

A system and method for mobile power generation is provided. The system includes a heat exchange system configured to reduce heat associated with a power generator. The system includes a silencer configured to receive exhaust gas from the power generator and transfer the exhaust gas to an exhaust stack for subsequent expulsion from the system. The silencer is positioned proximate to the heat exchange system and is at least partially thermally isolated from the heat exchange system. The exhaust stack is routed through a passage associated with the heat exchange system and is at least partially thermally isolated from the heat exchange system. The silencer can be positioned at least partially within a volume defined by the heat exchange system. Ventilation stack for the system can be routed through the volume defined by the heat exchange system.

### FIELD OF THE INVENTION

The present invention pertains to the field of power generation, and in particular to a method and system for mobile power generation.

### BACKGROUND

Mobile power generation involves transporting the power generation equipment to a location where grid power is inaccessible or may be temporarily unavailable or insufficient to meet the power demand. Various components of the power generation equipment, such as the generator, heat exchangers, gearbox, engine and associated components can be heavy and bulky and occupy a significant amount of space on a mobile platform that is used to transport such equipment to a site. Power generation equipment may require several mobile platforms due to road transport size and weight limits and other transport regulations. On site assembly of components that are transported separately may require a substantial amount of time, delaying power generation which may be urgently needed and contributing to downtime. Alignment and positioning of various components on the mobile platform may become affected during transport, particularly to remote locations that may use unpaved roads. Once on site, setting up the power generation may necessitate repositioning, realignment and leveling of the mobile platform and its components before the power generation equipment can be utilized. During operation, maintenance and repairs require personnel to access various components of the power generation equipment. In order to access such components, panels may need to be removed, and some components may need to be repositioned or disassembled, which leads to increased downtime.

Therefore, there is a need for methods and systems for mobile power generation that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

According to embodiments of the present invention, there is provided a mobile electrical power generation system. The system includes a power generator configured to convert at least one type of hydrocarbon fuel into electricity. The system includes a silencer configured to receive exhaust gas from the power generator and transfer the exhaust gas to an exhaust stack for subsequent expulsion from the system. The system includes a heat exchange system configured to reduce heat associated with operation of the power generator. The silencer is positioned proximate to the heat exchange system. The silencer is at least partially thermally isolated from the heat exchange system. The exhaust stack is routed through a passage associated with the heat exchange system. The exhaust stack is at least partially thermally isolated from the heat exchange system.

According to an embodiment, the silencer may be positioned at least partially within a volume defined by the heat exchange system.

According to an embodiment, the passage associated with the heat exchange system may be positioned within a volume defined by the heat exchange system. The passage may have an opening adjacent at least one fan of the heat exchange system. The exhaust stack may be routed vertically towards the opening. The at least one fan may be positioned horizontally.

According to an embodiment, the passage associated with the heat exchange system may include a ventilation stack configured to expel air surrounding the silencer and the power generator.

According to an embodiment, the heat exchange system may include one or more heat exchangers, at least one fan and a support structure configured to support the one or more heat exchangers and the at least one fan. At least a portion of the support structure may be internal to the heat exchange system. The system may include a movable transport, and the support structure may be mounted on the movable transport using shock-absorbent spacers. The support structure may be configured to support the one or more heat exchangers via the at least one fan.

According to an embodiment, the silencer may be at least partially enclosed in a shroud. The heat exchange system and the shroud may be at least partially connected using a flexible barrier configured, in a closed position, to seal a volume defined by the heat exchange system and the shroud from external air when the flexible barrier is in a closed position. The flexible barrier may be further configured, in an open position, to provide access to the volume defined by the heat exchange system.

According to an embodiment, the system may include a plurality of ventilation stacks configured to expel air surrounding the silencer and the power generator. A portion of the air surrounding the silencer and the power generator may pass through a heat exchanger into a volume defined by the heat exchange system. Each ventilation stack of the plurality of ventilation stacks may be connected to a shroud via a shock absorbent spacer. At least one ventilation stack of the plurality of ventilation stacks may be adjacent at least one fan of the heat exchange system. Each ventilation stack of the plurality of ventilation stacks may include an opening with a flap, and the flap may be configured to open when the at least one fan is turned on.

According to an embodiment, the heat exchange system may include at least one fan operable using a viscous clutch. The at least one fan and the viscous clutch may be configured to operate in a horizontal plane.

According to an embodiment, the system may include a wheeled chassis and at least two legs for positioning the system for operation, the at least two legs for adjusting at least one of a pitch of the wheeled chassis and a roll of the wheeled chassis. Each leg of the at least two legs may be independently adjustable.

According to an embodiment, the system may include a wheeled chassis and two legs for positioning the system for operation, the two legs for adjusting at least one of a pitch of the wheeled chassis and a roll of the wheeled chassis, the two legs being independently adjustable.

According to an embodiment, the power generator may include an engine coupled to a gearbox using a flexible coupling. An alignment between the engine and the gearbox may be adjustable at least in part by positioning the two legs or the at least two legs. Positioning the two legs or the at least two legs may cause a vertical distortion of the wheeled chassis.

According to an embodiment, the system may include a flexible cover configured to, in a closed position, seal an air space proximate the power generator, and, in an open position, provide access to the power generator. The flexible cover may be further configured to slide side to side between the open position and the closed position.

According to an embodiment, the power generator may include a reciprocating engine.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1A is a schematic illustration of a side view of a mobile electrical power generation system, in accordance with an embodiment of the present disclosure.

FIG. 1B is a schematic illustration of a top view of the mobile electrical power generation system of FIG. 1A, in accordance with an embodiment of the present disclosure.

FIG. 1C is a schematic illustration of a bottom view of the mobile electrical power generation system of FIG. 1A, in accordance with an embodiment of the present disclosure.

FIG. 2A is a schematic illustration of using legs of a mobile electrical power generation system for adjusting of a roll of a chassis of the system, in accordance with an embodiment of the present disclosure.

FIG. 2B is a schematic illustration of a side view of a mobile electrical power generation system supported on even ground using support legs and leveling legs, in accordance with an embodiment of the present disclosure.

FIG. 2C is a schematic illustration of using leveling legs of a mobile electrical power generation system for adjusting of a pitch of a chassis of the system and compensating for chassis distortion, in accordance with an embodiment of the present disclosure.

FIG. 3A is a schematic illustration of a side view of an exhaust gas flow of a mobile electrical power generation system, in accordance with an embodiment of the present disclosure.

FIG. 3B is a schematic illustration of a top view of the exhaust gas flow of the mobile electrical power generation system of FIG. 3A, in accordance with an embodiment of the present disclosure.

FIG. 4A is a schematic illustration of a side view of an air flow through a volume defined by a cover of a mobile electrical power generation system, in accordance with an embodiment of the present disclosure.

FIG. 4B is a schematic illustration of a top view of the air flow through the volume defined by the cover of the mobile electrical power generation system of FIG. 4A, in accordance with an embodiment of the present disclosure.

FIG. 5A is a schematic illustration of a support structure of a heat exchange system, in accordance with an embodiment of the present disclosure.

FIG. 5B is a schematic illustration of a load transfer path within a heat exchange system into a support structure, in accordance with an embodiment of the present disclosure.

FIG. 5C is a schematic illustration of another load transfer path within a heat exchange system into a support structure, in accordance with an embodiment of the present disclosure.

FIG. 6A is a schematic illustration of a side view of a heat exchange system mounted on a movable transport using shock-absorbent spacers, in accordance with an embodiment of the present disclosure.

FIG. 6B is a schematic illustration of a front view of a heat exchange system mounted on a movable transport using shock-absorbent spacers, in accordance with an embodiment of the present disclosure.

FIG. 7A is a schematic illustration of a side view of an air flow from a volume defined by a cover of a mobile electrical power generation system to a volume defined by a heat exchange system via a supplementary heat exchanger, in accordance with an embodiment of the present disclosure.

FIG. 7B is a schematic illustration of a top view of the air flow of FIG. 7A, in accordance with an embodiment of the present disclosure.

FIG. 8A is a schematic illustration of a side view of an air flow through a heat exchange system of a mobile electrical power generation system, in accordance with an embodiment of the present disclosure.

FIG. 8B is a schematic illustration of a top view of the air flow of FIG. 8A, in accordance with an embodiment of the present disclosure.

FIG. 9A is a schematic illustration of a flexible cover in a first open position, in accordance with an embodiment of the present disclosure.

FIG. 9B is a schematic illustration of the flexible cover in a second open position, in accordance with an embodiment of the present disclosure.

FIG. 9C is a schematic illustration of the flexible cover in a third open position, in accordance with an embodiment of the present disclosure.

FIG. 10 is a schematic illustration of steps of a method for transferring of the exhaust gas produced by the power generator, in accordance with an embodiment of the present disclosure.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs. The numbers and numbers combined with letters correspond to the component labels in all the figures.

Embodiments of the present invention relate to accommodating engine exhaust components within an enclosure defined by heat exchangers. Embodiments of the present invention relate to mobile power generation and, in particular, to a trailer-mounted mobile power generation system that may include a reciprocating engine system that operates using a fuel, such as natural gas, to generate electrical power.

Natural gas is commonly used for power generation as the fuel is abundant and relatively clean compared to coal, oil, or diesel power generation. Increasingly, this type of power generation is utilized for on-site power generation in various applications, such as serving the increasing power needs of data centers, to provide backup or peak power generation adjacent to other forms of power generation, to provide off-grid power on natural resource sites such as fracking sites, in emergency deployments where grid power may be unavailable or insufficient, etc. Embodiments of the present disclosure facilitate compact arrangement of power generator components on a mobile platform at least in part by accommodating engine exhaust components within an enclosure defined by heat exchangers, provide for robust setup of the mobile power generation module on-site using adjustable legs, provide for improved serviceability of power generator components using a flexible transport cover, or a combination thereof.

Embodiments of the present disclosure pertain to systems and methods for improving off-grid mobile power generation by limiting the transport footprint through a novel transport packaging solution, improving accessibility of power generator components, facilitating alignment of power generator components for operation, or a combination thereof. In typical mobile power generation systems, a significant portion of the space available on a mobile transport, the size and weight of which is subject to applicable transport regulations, is taken up by the engine exhaust and silencer, the engine intake, the heat exchanger package, the engine, generator or alternator, and any gearboxes, transmissions, and couplings.

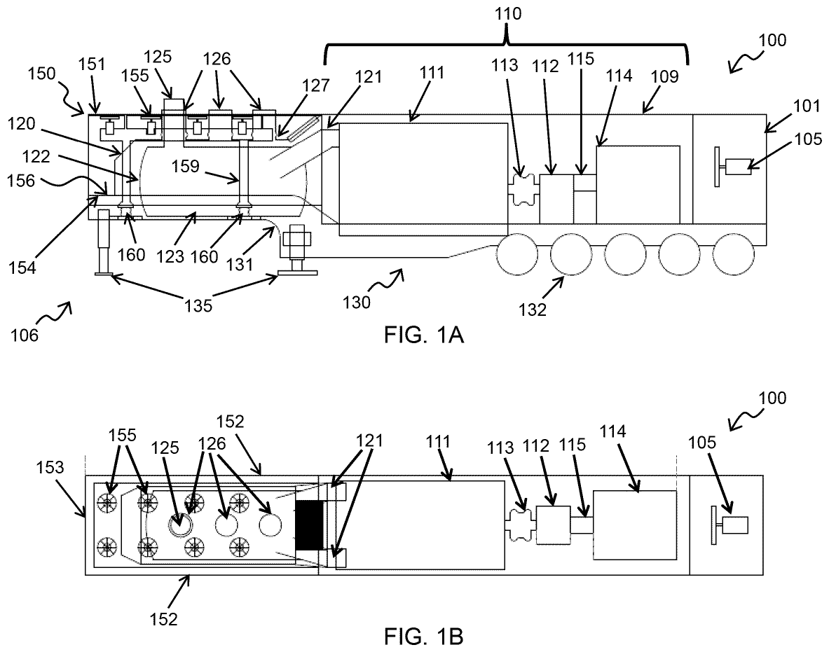

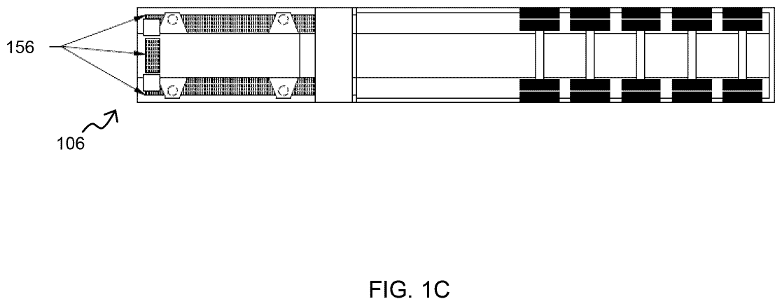

FIGS. 1A and 1B show side view and top view, respectively, of a mobile electrical power generation system 100, accordingly to an example embodiment of the present disclosure. The system 100 includes an electrical enclosure 101 for various electrical components and system controls, an air intake 105 which may include suitable filtering to reduce dust, moisture, and/or other unwanted particles or gases from entering the system. A power generator cover 109 of the system 100 encloses a power generator 110 that includes an engine 111, a gearbox 112, a flexible coupling 113 between the engine 111 and the gearbox 112, a generator 114 and a coupling 115 between the gearbox 112 and the generator 114. The power generator cover 109 is connected to a shroud 120 that encloses the silencer 122 which receives exhaust gas from the engine 111 via exhaust piping 121.

The system 100 includes a mobile transport 130 which includes a wheeled chassis 131 (also referred to herein as a chassis) which supports various components of the system 100, such as the electrical enclosure 101, the power generator 110, the silencer 122 with the shroud 120, and a heat exchange system 150. The mobile transport 130 includes wheeled axles 132. Five wheeled axles 132 are shown as a non-limiting example. The mobile transport includes legs 135. In a non-limiting example, two legs 135 may be provided at a heat exchange system end (i.e., front end 106) and two legs 135 may be provided under the silencer proximate to the engine.

The system 100 includes a heat exchange system 150. The heat exchange system includes at least one heat exchanger (not shown) positioned on one or more of the sidewalls 152 and the front wall 153 of the heat exchange system 150. The heat exchange system includes a plurality of fans 155 positioned horizontally on a top wall 151 and operable to draw the air through the at least one heat exchanger and out of the volume defined by the heat exchange system thorough the fans 155. The heat exchange system 150 includes a support structure 159 mounted on the chassis 131 using shock-absorbent spacers 160.

The silencer 122 transfers the exhaust gas to an exhaust stack 125 which expels the exhaust gas vertically from the system. The exhaust stack 125 is routed through a passage associated with the heat exchange system 150, which in this example embodiment is one of the ventilation stacks 126. The ventilation stacks 126 are connected to the shroud 120 using flexible joints or shock-absorbent spacers 127. A lower portion 123 of the silencer 122 is positioned below a bottom wall 154 of the heat exchange system 150 and may be positioned below portion of chassis 131 proximate the silencer 122. The bottom wall 154 includes a flexible barrier 156 that, in a closed position, seals the volume defined by the heat exchange system 150 and the shroud 120 from external air and, when opened, provides access to the volume within the heat exchange system 150.

FIG. 1C shows a bottom view of the mobile electrical power generation system 100 having the flexible barrier 156.

In embodiments, a mobile electrical power generation system, referred to herein as the system, includes a power generator configured to convert at least on type of hydrocarbon fuel into electricity. Non-limiting examples of hydrocarbon fuel types include natural gas, gasoline, diesel, propane, butane, kerosene, or any suitable combination thereof. The hydrocarbon fuel may be a fossil fuel, a biofuel, a synthetic fuel, an electrofuel, or any suitable combination thereof. The power generator includes an engine which may be of any type and configuration suitable for mobile power generation, such as a turbine engine or a reciprocating engine.

In an embodiment, the engine may be a reciprocating engine. A reciprocating engine is associated with increased operational efficiency, relative ease of maintenance, and adaptability to fluctuating power demands. The reciprocating engine may be selected to operate using a suitable hydrocarbon fuel, such as natural gas.

In embodiments, a gearbox or a similar transmission system can be used between other components of the power generation package to manage the operating speed of the engine. The gearbox may be located between the engine and a generator or alternator of the power generator, to facilitate operation of the engine and optimize power generation. A reciprocating engine may have a preferred (e.g., optimum) operational speed in the range of 900-3000 rotations per minute (RPM). An alternating current (AC) generator may be optimally operable for example at 1800 RPM or 3600 RPM to generate 60 Hz power, or 1500 RPM or 3000 RPM to generate 50 Hz power. The gearbox or transmission may be used to accommodate any differences in operational or preferred RPM speeds for the engine, the generator, or both the engine and the generator. For example, the gearbox or transmission may be used to facilitate operation of the engine at 1500 RPM and operation of the generator at 1800 RPM.

In embodiments, the power generator includes a generator, which may be an alternator, for generating electric power which can then be transmitted and applied to an electrical load. The power generated by the generator may be 3-phase AC power, for example.

In embodiments, one or more couplings may be used between components of the power generator, such as between the engine and the gearbox, and between the gearbox and the generator. Coupling the engine and the gearbox, as well as the gearbox and the generator, increases operational efficiency and reduces operational wear on bearings and other surfaces that move or are adjacent to moving parts of the engine, gearbox and generator. The mobile transport and its chassis, which supports various components of the power generator, may flex during transport to absorb some shock and vibration associated with transportation. During on-site operation, the mobile transport, which also supports the system during operation, may be positioned on soft or uneven terrain. As a result, some misalignment between components is likely. Therefore, use of a flexible coupling that allows for some tolerance to motion and flexibility is advantageous.

In some embodiments, the gearbox may be fixedly mounted to another component, such as the generator, and a flexible coupling may be used between the gearbox and the engine. The flexible coupling may include or be made of a flexible carbon composite material. In a non-limiting example, a Geislinger Gesilco® BC/BF flexible coupling may be used between the engine and the gearbox.

In embodiments, mobile transport may include at least two legs for leveling the mobile platform for on-site operation and to provide additional stability to the power generation equipment during operation. Some or all of the legs may be independently adjustable to enable adjusting the pitch of the chassis, the roll of the chassis, or both, pitch and roll and the chassis. Some or all of the legs may be adjustable using manual mechanical means. Some or all of the legs may be adjustable using actuators that are operable manually, hydraulically, pneumatically, electrically, or a combination thereof. In some embodiments the mobile transport includes two legs for leveling the mobile platform.

In some embodiments, a visual means for positioning of the chassis using the legs may be provided and may include one or more of a mechanical indicator (e.g., a leveling bead), and an electronic indicator (e.g., a display).

In some embodiments, adjusting the legs may cause a vertical distortion of the chassis, such as twisting, flexing, etc. The mobile transport may be positioned on an uneven ground for operation on-site, which may cause a distortion (e.g., twisting, flexing, bowing, etc.) of the chassis and a misalignment of some components of the power generation equipment mounted on the chassis, such as the engine, the generator (or alternator), and the gearbox. Components of the mobile transport and the chassis may be suitably selected to allow for such distortions within tolerance.

In some embodiments, an alignment between power generator components on the chassis may be adjustable using some or all of the legs. For example, the engine may be coupled to the gearbox using a flexible coupling that permits a certain level of misalignment within tolerance. Adjusting the legs can cause a vertical distortion of the chassis, thereby contributing to alignment or realignment of components, such as the engine and the gearbox coupling.

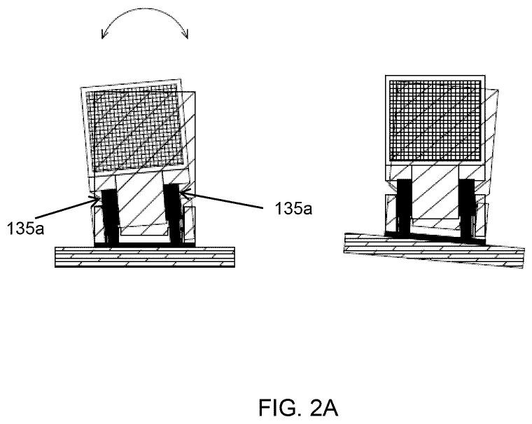

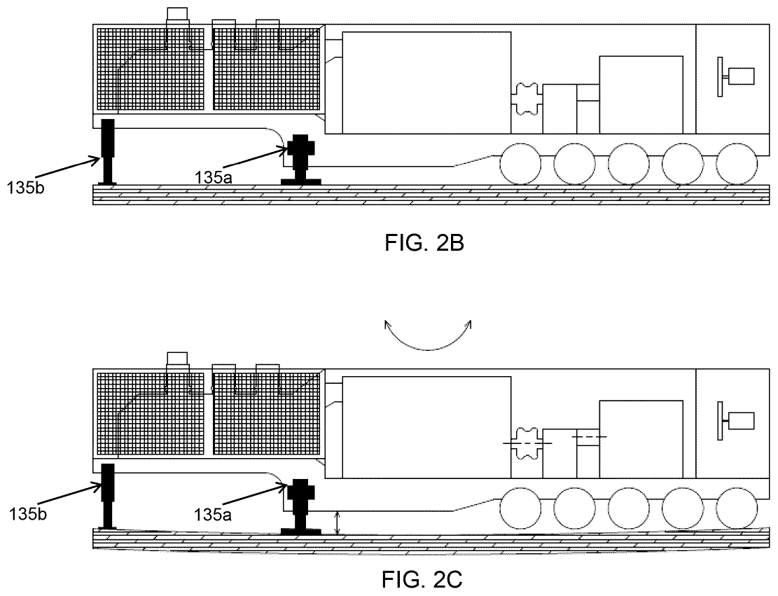

In an embodiment, legs may include two support legs at (e.g., support legs 135b of FIGS. 2B and 2C) a front end of the system for connecting and disconnecting the system from a transport vehicle and for supporting the system for operation on site. In some cases, independently adjustable support legs my be used to adjust a roll of the chassis.

In an embodiment, legs may include two leveling legs (e.g., leveling legs 135a of FIGS. 2A, 2B and 2C) which may be positioned for example under a region spanning the portion of the silencer adjacent the engine, and the portion of the engine adjacent the silencer. Leveling legs may be used for one or more of: to compensate for vertical distortion of the chassis due to uneven or soft ground on site, to adjust alignment between the engine and the gearbox coupled to the engine vis a flexible coupling, to adjust a pitch of the chassis, and to adjust a roll of the chassis.

In an embodiment, two legs may be provided for positioning the system for operation. Such two legs may be independently adjustable and can be used for adjusting at least one of a pitch of the wheeled chassis and a roll of the wheeled chassis. Such two legs may, for example, combine the functions of support legs and leveling legs as described above, and be suitably positioned according to the operational requirements, functionalities, and tolerances.

FIG. 2A shows using two leveling legs 135a to adjust the roll of the chassis. FIG. 2B shows the system positioned on level ground using leveling legs 135a and support legs 135b. FIG. 2C shows the system positioned on uneven ground where leveling legs 135a are used for adjusting the pitch of the chassis and to compensate for vertical distortion of the chassis (e.g., bowing) while the support legs 135b support the front end of the chassis.

In embodiments, the mobile electrical power generation system includes a silencer configured to receive exhaust gas from the power generator and transfer the exhaust gas to an exhaust stack for subsequent expulsion from the system. The silencer is provided for reducing the noise produced by the power generator and, in particular, by the engine of the power generator.

In embodiments, the silencer is positioned proximate to a heat exchange system of the mobile electrical power generation system, and the silencer is at least partially thermally isolated from the heat exchange system. The silencer may be positioned at least partially within a volume defined by the heat exchange system. Heat exchange system configurations can include a volume or space between various components, such as heat exchangers (e.g., radiators) and fan(s), that is substantially or at least partially unoccupied. Embodiments of the present invention pertain to utilizing this volume for positioning the silencer at least partially therein, advantageously reducing space requirements of the overall mobile electrical power generation system. Such positioning necessitates suitable thermal insulation of at least those parts, components, or regions of the silencer that are generally proximate to the heat exchange system and, in particular, within such volume of the heat exchange system.

In an embodiment, at least the parts of the silencer proximate to the heat exchange system and, in particular, within the volume defined by the heat exchange system, are thermally insulated from the heat exchange system. Silencer, receiving the high temperature exhaust gas from the engine, can itself be at high temperature during operation, while the heat exchange system operates to reduce heat associated with the operation of the power generator that is diverted to the heat exchange system via suitable piping or routing using a suitable coolant (e.g., gas coolant, liquid coolant).

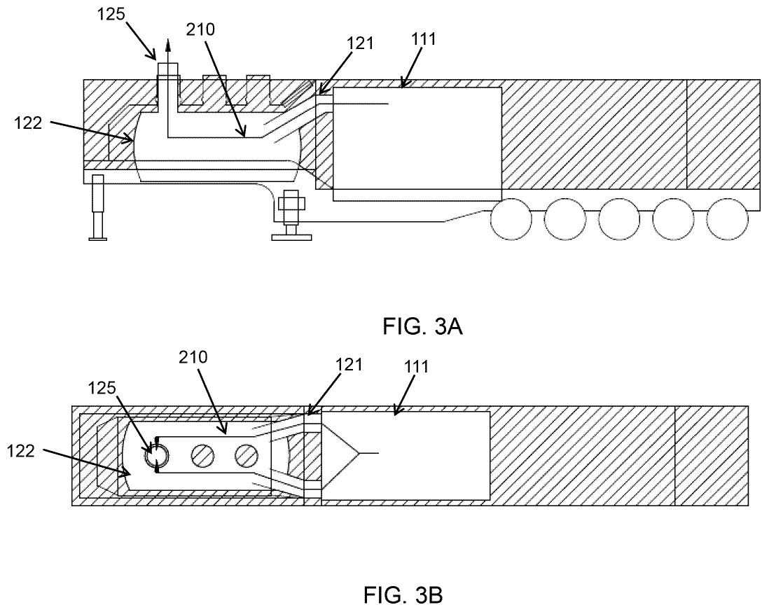

FIGS. 3A and 3B show exhaust gas flow 210, according to an embodiment. The exhaust gas produced by the engine 111 passes through the exhaust piping 121 into the silencer 122. The silencer 122 transfer the exhaust gas to the exhaust stack 125 which expels the exhaust gas from the system.

In embodiments, the silencer may be at least partially enclosed in a shroud configured to limit transfer of heat (e.g., thermally insulate) from the silencer and any other components (e.g., engine exhaust routing) enclosed by the shroud to components external to the shroud, such as components of the heat exchange system. Any portion or components of the silencer and associated piping that are positioned within the volume defined by the heat exchange system may be enclosed in the shroud.

In embodiments, the shroud provides a physical barrier, such as a heat shield, between the silencer and the heat exchange system and may be thermally insulated. Additionally or alternatively, the silencer (and any associated components within the volume of or proximate to the heat exchange system) may be thermally isolated from the heat exchange system using suitable shielding that limits transfer of heat, such as thermal wrapping, (e.g., fiberglass) exhaust blanketing, reflective shields, other devices or structures configured to reflect or contain thermal energy, as understood by a person skilled in the art, or a combination thereof.

The shroud may be spaced apart from the silencer and any other components eclosed therein to allow for airflow to cool the shroud enclosure. Air intake for the shroud enclosure airflow may utilize an external air intake for the mobile electrical power generation system. The intake air entering the system may flow over the power generator, picking up any radiant heat produced thereby, and enter the shroud enclosure.

In embodiments, a plurality of ventilation stacks may be provided to expel air surrounding or flowing over the silencer and the power generator. Such air enters the system via an air intake, for example positioned on a side of the system furthest from the silencer (e.g., back end of the system), such that that air passes from the air intake for the system, over and surrounding the power generator and further over the silencer and related exhaust piping and components. Afterwards, the air is expelled via the plurality of ventilation stacks. The one or more of the ventilation stacks may be substantially vertical, routing and expelling the air upwards through a top wall of the heat exchange system. However, it is to be understood that in some embodiments, at least one of the ventilation stacks is substantially vertical, other ventilation stacks may be oriented in alternate orientations.

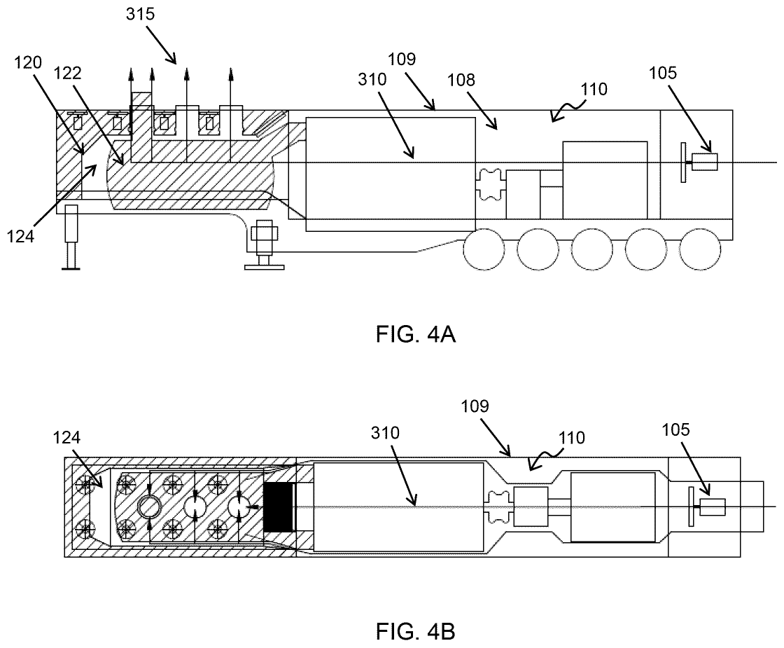

With reference to FIGS. 4A and 4B, external air may enter the volume 108 defined by the power generator cover 109 via the air intake 105, flow 310 over the power generator 110, through the shroud enclosure 124 and exit 315 through the ventilation stacks.

In embodiments, at least one ventilation stack may be positioned adjacent at least one fan of the heat exchange system. Such at least one fan may be positioned, for example, on the top wall of the heat exchange system, with the at least one ventilation stack expelling air vertically therethrough. Advantageously, positioning of the ventilation stacks within the volume defined by the heat exchange system utilizes such volume, thereby improving compactness of the system and reducing its overall size footprint. The ventilation stacks may be thermally isolated from the heat exchange system using suitable methods and devices, for example as described elsewhere herein with reference to thermally isolating of the silencer.

One or more of the ventilation stacks may be connected to the shroud at an upper region thereof and extend upwardly therefrom through the top wall of the heat exchange system. The ventilation stacks may be in substantially rigid communication (e.g., rigidly connected, welded, bolted, secured) with a support structure of the heat exchange system, for example at a portion of the ventilation stacks proximate a wall of the heat exchange system where the air is expelled from the ventilation stacks. The ventilation stacks may be connected to the shroud using flexible joints or via shock-absorbent spacers to allow for minor (e.g., within tolerance) movement or vibration of the heat exchange system relative to the shroud during transport, and/or to limit transfer of vibrations generated by the power generator to the heat exchange system during operation.

Advantageously, turning on at least one fan of the heat exchange system that is adjacent at least one of the ventilation stacks creates a low pressure in a region above such at least one fan and adjacent the at least one ventilation stack, which causes a flap (or multiple flaps may be provided per ventilation stack opening) at the opening of the ventilation stack to open and begin drawing air out from within the power generator enclosure and the silencer shroud, similar to a Venturi effect. Notably, in this case, it is not necessary for the air intake fan to be operating, and turning on at least the fan adjacent to at least one ventilation stack can be sufficient the flap of the ventilation stack to open.

In embodiments, the exhaust stack is routed from the silencer through a passage associated with the heat exchange system and the exhaust stack is at least partially thermally isolated from the heat exchange system. Such passage may be routed through a volume defined by the heat exchange system. The exhaust stack may be routed vertically towards an opening, which may be adjacent at least one fan of the heat exchange system that is positioned horizontally at a top wall of the heat exchange system.

In an embodiment, the passage associated with the heat exchange system and having the exhaust stack routed therethrough may include or ay be a ventilation stack. In an example configuration, the exhaust stack may be positioned within such ventilation stack. In other words, both the exhaust stack and the ventilation stack may be axially aligned and the exhaust stack may be routed through the ventilation stack, such that during operation, the exhaust gas exits the system through the exhaust stack while a portion of the ventilation air surrounding the power generator and the silencer exits the system through the ventilation stack around the exhaust stack routed therethrough.

In embodiments, the mobile electrical power generation system includes a heat exchange system configured to reduce heat associated with the operation of the power generator. The heat associated with the power generator includes heat produced by the engine and transferred to the heat exchange system using an engine coolant system (e.g., using coolant fluid). The heat associated with the power generator may include heat produced by one or more other components of the power generator such as the gearbox, the coupling(s), the generator or alternator, electrical equipment, etc. Some of the heat associated with the power generator may be transferred by convection, for example via the air surrounding the power generator and the silencer within the volume defined by the power generator cover. Reducing the heat associated with the operation of the power generator includes receiving such heat, for example via the engine or power generator cooling system, at the heat exchange system, and in particular at one or more heat exchangers thereof, and reducing the received heat, for example by passing external air through the one or more heat exchangers into the volume defined by the heat exchange system and expelling it via at least one fan of the heat exchange system. The relatively cool external air passing proximate a relatively hot heat carrying medium, such as a coolant, in the one or more heat exchangers, cools the heat carrying medium thereby reducing the heat associated with the operation of the power generator, which is then cycled back to the engine or power generator cooling system where it may receive more heat therefrom and deliver it back to the heat exchange system for subsequent cooling.

In an embodiment, the heat exchange system may include multiple heat exchangers which may be arranged in a prism formation. The prism may be of any suitable geometrical shape (e.g., cube, rectangle, geometric prism) according one or more of: the heat exchanger type, heat exchanger quantity, dimensional requirements or constraints of the heat exchange system, and dimensional requirements or constraints of the mobile electrical power generation system. The prism may be formed by the one or more heat exchangers and one or more of the silencer shroud, the at least one fan of the heat exchange system, the flexible barrier between the heat exchange system and the shroud, and a hard surface (e.g., fire barrier, another barrier, a portion of chassis.

In an embodiment, the prism may be rectangular. The heat exchange system may include a top wall having the at least one fan, a bottom wall defined by the silencer shroud and the flexible barrier, a back wall adjacent to the engine and defined at least in part by the silencer shroud and exhaust piping, a front wall opposite the back wall, and two sidewalls opposite each other and adjacent the back wall and the front wall. The one or more heat exchangers may be mounted on one or more of the side walls and the front wall.

In embodiments, the quantity and configuration of walls of the heat exchange system and the prism are non-limiting. For example, in some cases, an angled wall may be provided between the top wall and a side wall or the front all, or at the corner where the top wall, the front wall and one of the side walls are adjacent each other. In some cases, one or more walls may be curved. Such configurations may, for example, be advantageous to improve aerodynamics of the system during transport, and/or to limit accumulation of precipitation on parts of the system such as the top wall.

In an embodiment, one or more walls of the heat exchange system may include a flexible barrier configured to contribute to sealing the volume within the heat exchange system when closed, and to provide access to the volume within the heat exchange system when opened, for example for maintenance, inspection and repairs.

In embodiments, the heat exchange system includes a support structure configured to support the one or more heat exchangers and at least one fan of the heat exchange system. The support structure may be internal to the heat exchange system, and in particular internal to the one or more heat exchangers and the at least one fan thereof. In other words, the fan(s) and the heat exchanges may be mounted on the outside of the support structure. The support structure may support the ventilation stacks which may be suitably mounted thereon. The support structure may support other equipment associated with the heat exchange system, such as fan motor(s), and may support auxiliary equipment. The support structure may be mounted on the movable transport of the system (e.g., onto the chassis) using shock-absorbent spacers (e.g., rubber isolators).

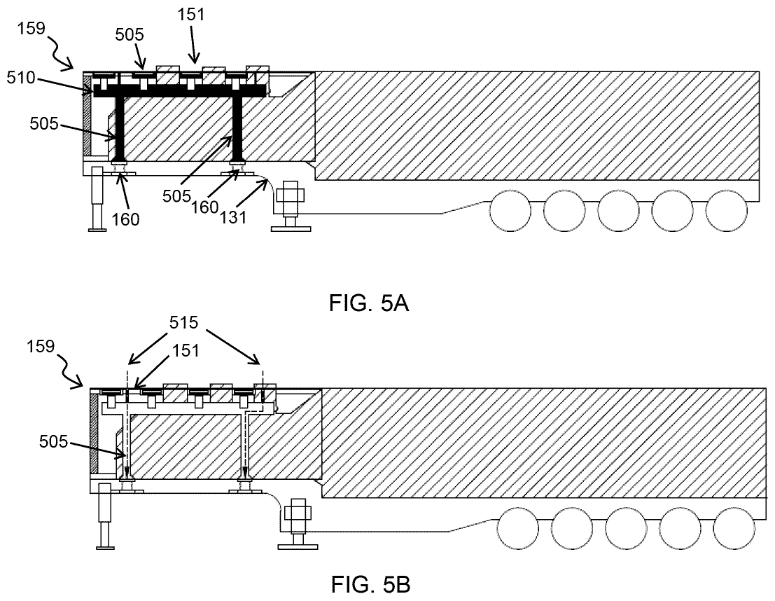

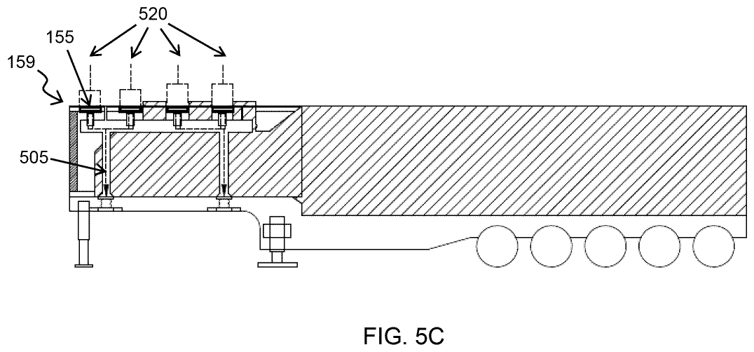

FIG. 5A shows a side view of a support structure 159 of the heat exchange system, according to an example embodiment. The support structure 159 includes vertical supports 505 connected or integral with the horizontal support 510, which may be a single connected or integral one-piece support. In a non-limiting example, four vertical supports 505 may be provided (only 2 are shown). Vertical supports 505 are mounted on the chassis 131 using shock-absorbent spacers 160 such that each vertical support connecting the support structure 159 to the chassis 131 is mounted on a respective shock-absorbent spacer 160 (only 2 are shown in the side view).

In some embodiments, the support structure 159 supports the fans 155 which are connected to the top wall 151 of the heat exchange system using suitable load bearing supports. The top wall 151 may be connected, via suitable load-bearing supports to other walls (e.g., front wall, side walls) and components (e.g., one or more heat exchangers, ventilation stacks) of the heat exchange system, thereby providing support for such walls and components. In other words, the fan(s) at the top wall of the heat exchange system may be mounted on the support structure and the fan(s) may be load-bearing in terms of supporting the top wall and other walls and components of the heat exchange system. Such configuration of the support structure of the heat exchange system, in combination with the ventilation stacks being mounted using shock-absorbent spacers and the flexible barrier between the heat exchange system and the shroud, allows the heat exchange system to be isolated (i.e., in terms of shock transfer, vibration transfer), within tolerance defined at least in part by the shock-absorbent spacers 160, from other components of the mobile electrical power generation system during transport and operation.

In some embodiments, additionally or alternatively, the top wall may be directly connected to the support structure, for example to the horizontal support 510 thereof.

FIG. 5B shows an example load transfer path 515 via top wall 151 within the heat exchange system into the vertical supports 505 of the support structure 159.

In some embodiments, additionally or alternatively, any one or more of the other walls (e.g., front wall, side walls) and/or components (one or more heat exchangers, one or more ventilation stacks) may be directly connected to the support structure.

In some embodiments, the support structure may be configured to support one or more heat exchangers via at least one fan. In such cases, the at least one fan (e.g., face(s) or suitable frame(s) thereof) may be load bearing in terms of supporting, in part or fully, the weight of the one or more heat exchangers, while the one or more fans is directly supported by the support structure.

FIG. 5C shows another example load transfer path 520 via fans 155 within the heat exchange system into the vertical supports 505 of the support structure 159.

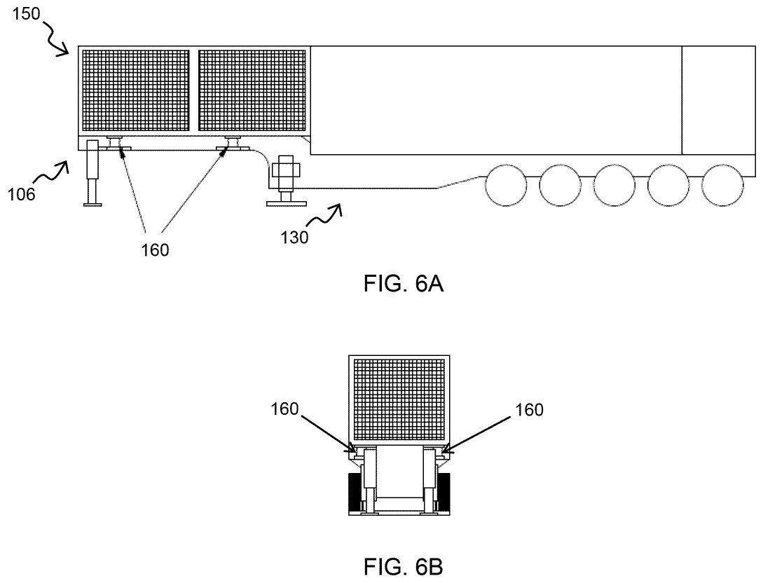

FIGS. 6A and 6B show a side view and a front view of a system having the heat exchange system 150 mounted onto the movable transport 130 using shock-absorbent spacers 160.

In embodiments, the heat exchange system may be mounted onto the chassis to allow for a degree of movement, vibration or, both, movement and vibration, of the heat exchange system relative to the movable transport (and components which can be hard mounted thereon such as the silencer and the shroud), by mounting the support structure of the heat exchange system onto the movable transport using shock-absorbent spacers, by mounting the ventilation stacks onto the silencer shroud using shock-absorbent spacers, and by providing a flexible barrier between the heat exchange system and the shroud. Advantageously, such configuration facilitates a dampening effect for the heat exchange system during transport and operation by providing shock absorption.

In some embodiments, the support structure may be hard-mounted onto the movable transport or chassis, and any heat exchange system components that may benefit from decreased vibration or movement, such as the one or more heat exchanges, the at least one fan and some auxiliary equipment, may be mounted onto the support structure using shock-absorbent spacers.

In some embodiments, the support structure that is internal to the heat exchange system may be connected or coupled to an external support of the heat exchange system for enhancing the structural integrity (e.g., stiffness and strength) of the heat exchange system.

In some embodiments, the support structure may at least in part be made of tubing arranged in one or more adjacent or interconnected triangular patterns.

In an embodiment, some of the air surrounding the power generator and the silencer in the volume defined by the power generator cover and the air surrounding the shroud may pass through a heat exchanger. Such heat exchanger is supplementary to the one or more heat exchangers of the heat exchange system and differs in that the air passing through it is not external air, but the internal system ventilation air which has passed over the power generator and optionally at least in part through the shroud. A portion of such internal system ventilation air may be routed through the supplementary heat exchanger into the volume defined by the heat exchange system, advantageously improving cooling capacity of the heat exchange system.

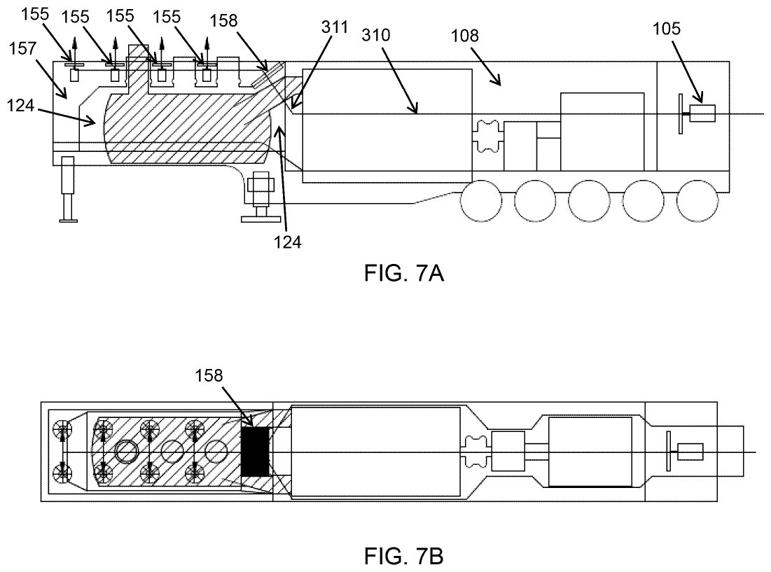

FIGS. 7A and 7B show airflow through the supplementary heat exchanger 158. External air may enter the volume 108 defined by the power generator cover via the air intake 105 and may enter the shroud enclosure 124. A portion 311 of this air 310 may pass through the supplementary heat exchanger 158 into the volume 157 defined by the heat exchange system, and exit the system via the fans 155.

In embodiments, the heat exchange system includes at least one fan configured to draw the air through the one or more heat exchangers. The fans may be configured to expel the air from the volume defined by the heat exchange system that is drawn into such volume through the one or more heat exchangers.

In some embodiments, a plurality of fans may be provided. Fans may be suitably positioned on one or more of the top wall, the front wall, and the side wall(s) of the heat exchange system.

In an embodiment, the heat exchange system may include a single fan suitably positioned, for example at the top wall of the heat exchange system.

In embodiments, the heat exchange system may include at least one fan operable using a viscous clutch. In some cases, fan(s) may be operable using one or more viscous clutches. Utilizing a viscous clutch may advantageously contribute to one or more of: reducing the cost of the system due to lower maintenance and/or increased operational lifespan, and decreased complexity of the system due to lower requirement for electronic equipment associated with the viscous clutch compared, for example, to variable frequency drives (VFDs) for fan operation.

In an embodiment, at least one fan and the associated viscous clutch may be configured to operate (e.g., rotate) in a horizontal or near-horizontal plane with the airflow passing through the fan in a vertical or near-vertical direction and may be positioned at the top wall of the heat exchange system, for example. A pulse width modification (PWM) may be used to control a pump, valves, or both pump and valves, to increase or decrease the amount of a viscous fluid contacting the viscous clutch plates to match the fan speed to a requested speed. The PWM signal may be at least in part determined by a fan speed command received, for example over a Controller Area Network (CAN), a programmable logic controller or other control signal system or channel as would be readily understood by a worker skilled in the art.

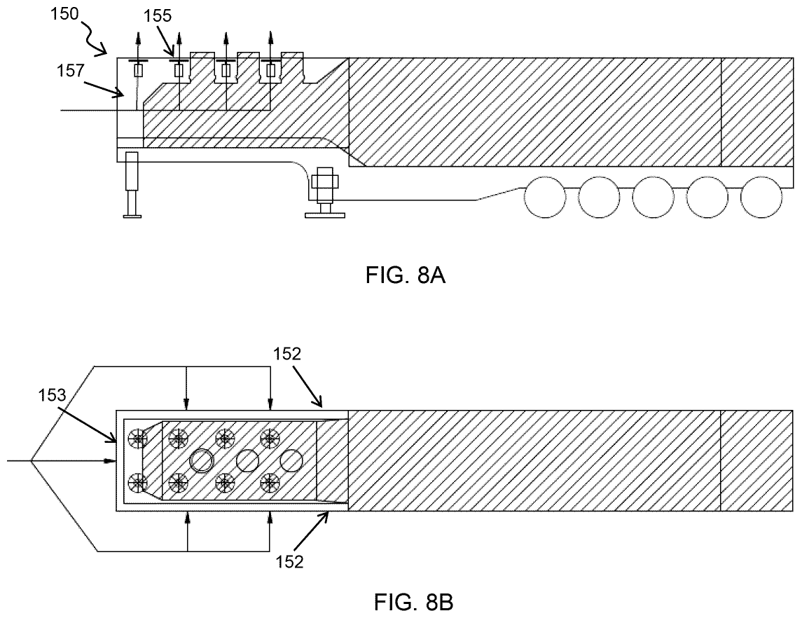

FIGS. 8A and 8B show airflow through the heat exchange system 150 having heat exchangers (not shown) on both side walls 152 and the front wall 153. External air may enter the volume 157 defined by the heat exchange system 150 through the heat exchangers and exit the system via the fans 155.

In embodiments, the mobile transport supports components of the power generation equipment, such as the heat exchange system, silencer and shroud, power generator, electrical equipment, cover, etc. The mobile transport includes a frame, such as a chassis, and two or more axles with wheels. The mobile transport is towable using suitable equipment and may be connected thereto or example at the front end of the system where the heat exchange system is positioned. Some components may be mounted directly onto the frame of the mobile transport. Some components may be mounted onto other frame(s) or components that are directly mounted on the chassis. Some components may be hard mounted, such as the shroud of the exhaust.

In embodiments, some components may be mounted via shock absorbent spacers, such as the frame of the heat exchange system, as described elsewhere herein. Engine mounts may be fixed directly to the frame of the mobile transport, or via intermediate shock-absorbent spacers, such as rubber isolators or equivalent material, to limit transmission of vibration produced by the engine to the mobile transport, thereby improving the stability of the mobile transport and components mounted thereon during operation. In an embodiment, shock-absorbent spacers (e.g., one or more spacers, which may be individual spacers or form a single shock-absorbent platform spacer) may be installed within an opening or a cavity in the mobile transport, such that the chassis or frame of the mobile transport fully or partially surrounds the shock-absorbent spacer(s).

In embodiments, the mobile electrical power generation system includes cover, also referred to herein as a power generator cover, which may be or may include a flexible cover. The flexible cover is configured to seal air space proximate the power generator (i.e., the volume 108 defined by the power generator cover 109 of FIGS. 4A and 4B). The cover contributes to managing the airflow around the power generator by sealing off the volume around it from external air, dust, weather elements, etc. The cover may be insulated to improve temperature and/or moisture control in the volume defined by the cover. The cover insulation may include multiple layers of polyvinyl chloride (PCV) sheeting and/or foam, another suitable material, or a combination thereof. The cover may include soundproofing elements or barriers to limit acoustic impact on the surrounding environment during system operation. Use of a flexible cover advantageously enables relatively quick access to various components eclosed thereby for inspection, maintenance and repairs, contributing to lower downtime. The flexible cover, or portions thereof, may be configured to open and close by sliding, for example sideways, or vertically. The flexible cover may include a plurality of rigid ribs configured to support the cover over the power generator. The flexible cover may be fixedly attached at one of its sides, or may have no fixedly attached sides.

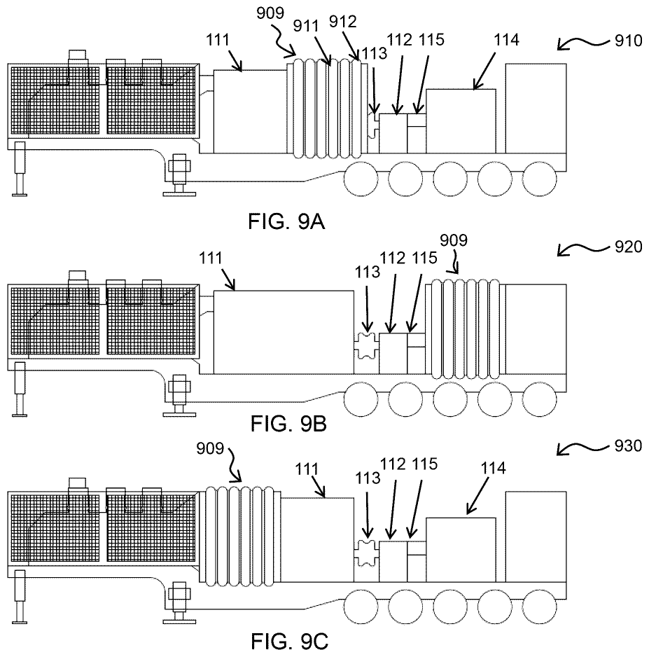

FIG. 9A shows flexible cover 909 in a first open position 910, according to an example embodiment. Notably, a closed position of the flexible cover may be as shown in FIG. 1A with reference to cover 109. In the first open position 910, the flexible cover 909 enables access to a portion of the engine 111, a portion of the coupling 113, the gearbox 112, coupling 115, and the generator 114. The flexible cover 909 includes a plurality of ribs 911 which support the flexible cover 909 in an open position, in a closed position, and facilitate the flexible cover 909 to fold or collapse to form a plurality of pleats 912.

FIG. 9B shows flexible cover 909 in a second open position 920, according to an example embodiment. In the second open position 920, the flexible cover 909 enables access to the engine 111, the coupling 113, the gearbox 112, and the coupling 115.

FIG. 9C shows flexible cover 909 in a third open position 930, according to an example embodiment. In the third open position 930, the flexible cover 909 enables access to another portion of the engine 111, the coupling 113, the gearbox 112, the coupling 115, and the generator 114.

Positions of the cover described herein with reference to FIGS. 9A, 9B and 9C are non-limiting examples. In other examples, the cover may be configured to open any amount according to the cover configuration and the requirements for access to system components.

In embodiments, bulb seals may be used on both a fixed end, if present, and a movable end of the flexible cover, providing an improved seal between the tarp and fixed end point, such as a portion of a non-flexible cover, a frame of the mobile transport, etc. An extruded channel may be used as a rail for the flexible cover, with the flexible cover using rollers or wheels to roll or slide along said rail. In some cases, an additional foam bulb may be fitted to the flexible cover to fit within a recessed portion of the extruded channel to improve sealing. In some cases, additional mechanical fastening means, such as a buckle or Velcro ™, may be provided between the flexible cover and the non-flexible components onto which the flexible cover is mounted or secured to further secure the cover in place.

In embodiments, some areas within the volume defined by the cover may include additional sound proofing, such as mass-loaded vinyl applied to hard surfaces (e.g., surface of the mobile transport).

Although embodiments disclosed herein have been described with reference to mobile electrical power generation, various features disclosed herein may be implemented in other systems that generally produce exhaust gas and have a heat exchange system having a volume defined thereby that may benefit by having such volume utilized for positioning of components that may not be typically a part of the heat exchange system.

In an example embodiment, a system may be provided that includes a heat exchange system configured to reduce heat associated with operation of one or more other systems (e.g., an engine, a motor, generator, transmission, other systems that may require cooling). Where one or more systems produce an exhaust gas, a silencer may be provided to receive the exhaust gas and transfer the exhaust gas to an (e.g., at least one) exhaust stack for subsequent expulsion from the system, the silencer being positioned proximate to the heat exchange system and at least partially thermally isolated from the heat exchange system. The exhaust stack of the silencer may be routed through a passage associated with the heat exchange system and may be at least partially thermally isolated from the heat exchange system. One or move ventilation stacks for the other systems, the silencer, or both, may be positioned proximate and, in particular, routed through a volume defined by, the heat exchange system.

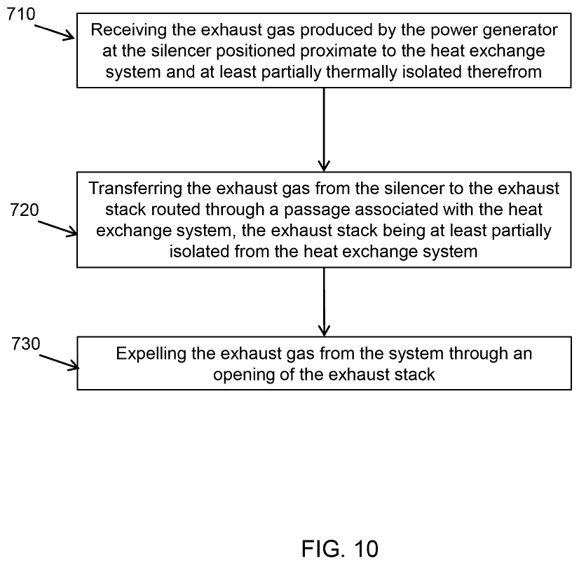

With reference to FIG. 10, there is provided a method 700 for transferring of the exhaust gas produced by the power generator. The method 700 includes receiving 710 the exhaust gas produced by the power generator at the silencer positioned proximate to the heat exchange system and at least partially thermally isolated therefrom. The method 700 includes transferring 720 the exhaust gas from the silencer to the exhaust stack routed through a passage associated with the heat exchange system, the exhaust stack being at least partially isolated from the heat exchange system. The method 700 includes expelling 730 the exhaust gas from the system through an opening of the exhaust stack.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that all within the scope of the present invention.

1. A mobile electrical power generation system, the system comprising:
a power generator configured to convert at least one type of hydrocarbon fuel into electricity;
a silencer configured to receive exhaust gas from the power generator and transfer the exhaust gas to an exhaust stack for subsequent expulsion from the system; and
a heat exchange system configured to reduce heat associated with operation of the power generator,
wherein the silencer is positioned proximate to the heat exchange system, wherein the silencer is at least partially thermally isolated from the heat exchange system; and
wherein the exhaust stack is routed through a passage associated with the heat exchange system, wherein the exhaust stack is at least partially thermally isolated from the heat exchange system.

2. The system of claim 1, wherein the silencer is positioned at least partially within a volume defined by the heat exchange system.

3. The system of claim 1, wherein the passage associated with the heat exchange system is positioned within a volume defined by the heat exchange system.

4. The system of claim 3, wherein the passage has an opening adjacent at least one fan of the heat exchange system.

5. The system of claim 4, wherein the exhaust stack is routed vertically towards the opening, and wherein the at least one fan is positioned horizontally.

6. The system of claim 1, wherein the passage associated with the heat exchange system comprises a ventilation stack configured to expel air surrounding the silencer and the power generator.

7. The system of claim 1, wherein the heat exchange system comprises one or more heat exchangers, at least one fan and a support structure configured to support the one or more heat exchangers and the at least one fan.

8. The system of claim 7, wherein at least a portion of the support structure is internal to the heat exchange system.

9. The system of claim 7, further comprising a movable transport, wherein the support structure is mounted on the movable transport using shock-absorbent spacers.

10. The system of claim 7, wherein the support structure is configured to support the one or more heat exchangers via the at least one fan.

11. The system of claim 1, wherein the silencer is at least partially enclosed in a shroud, and wherein the heat exchange system and the shroud are at least partially connected using a flexible barrier configured, in a closed position, to seal a volume defined by the heat exchange system and the shroud from external air when the flexible barrier is in a closed position.

12. The system of claim 11, wherein the flexible barrier is further configured, in an open position, to provide access to the volume defined by the heat exchange system.

13. The system of claim 1, further comprising a plurality of ventilation stacks configured to expel air surrounding the silencer and the power generator.

14. The system of claim 13, wherein a portion of the air surrounding the silencer and the power generator passes through a heat exchanger into a volume defined by the heat exchange system.

15. The system of claim 13, wherein each ventilation stack of the plurality of ventilation stacks is connected to a shroud via a shock absorbent spacer.

16. The system of claim 13, wherein at least one ventilation stack of the plurality of ventilation stacks is adjacent at least one fan of the heat exchange system.

17. The system of claim 16, wherein each ventilation stack of the plurality of ventilation stacks comprises an opening with a flap, and wherein the flap is configured to open when the at least one fan is turned on.

18. The system of claim 1, wherein the heat exchange system comprises at least one fan operable using a viscous clutch.

19. The system of claim 18, wherein the at least one fan and the viscous clutch are configured to operate in a horizontal plane.

20. The system of claim 1, further comprising a wheeled chassis and at least two legs for positioning the system for operation, the at least two legs for adjusting at least one of a pitch of the wheeled chassis and a roll of the wheeled chassis.

21. The system of claim 20, wherein each leg of the at least two legs is independently adjustable.

22. The system of claim 1, further comprising a wheeled chassis and two legs for positioning the system for operation, the two legs for adjusting at least one of a pitch of the wheeled chassis and a roll of the wheeled chassis, and wherein the two legs are independently adjustable.

23. The system of claim 21, wherein the power generator comprises an engine coupled to a gearbox using a flexible coupling, wherein an alignment between the engine and the gearbox is adjustable at least in part by positioning the at least two legs.

24. The system of claim 23, wherein positioning the at least two legs causes a vertical distortion of the wheeled chassis.

25. The system of claim 1, further comprising a flexible cover configured to:
in a closed position, seal an air space proximate the power generator; and in an open position, provide access to the power generator.

26. The system of claim 25, wherein the flexible cover is further configured to slide side to side between the open position and the closed position.

27. The system of claim 1, wherein the power generator comprises a reciprocating engine.
